(19) United States
(12) Patent Application Publication
(10) Pub. No.: US 2026/0168746 A1
(43) Pub. Date: Jun. 18, 2026

(54) PROTECTIVE GRID FOR A HEAT EXCHANGER

(71) Applicant: VALEO SYSTEMES THERMIQUES, La Verriere (FR)

(72) Inventors: Luis LUNA, San Luis Potosi (MX); Ricardo SANCHEZ, San Luis Potosi (MX); Jesus LEYJA, San Luis Potosi (MX)

(73) Assignee: VALEO SYSTEMES THERMIQUES, La Verriere (FR)

(21) Appl. No.: 18/984,269

(22) Filed: Dec. 17, 2024

(51) Int. Cl. F28F 19/00

(52) U.S. Cl. CPC F28F 19/002; F28F 2265/02

(57) ABSTRACT

A protective grid for a heat exchanger with a bottle, including a front face and a rear face, opposed to the front face, the protective grid being attachable to the heat exchanger so that the rear face can face a side of the heat exchanger. The protective grid is configured to extend over the bottle and follow a curvature of the bottle.

### TECHNICAL FIELD

The present invention relates to the field of heat exchangers and in particular to heat exchangers arranged on the front face of a motor vehicle.

### BACKGROUND OF THE INVENTION

Heat exchangers interact with a fluid circulation loop in order to generate heat exchange between the outside air of the motor vehicle directed to pass through these heat exchangers and the fluid. It may be a coolant fluid, a refrigerant fluid or a gaseous fluid such as an intake air flow for an internal combustion engine.

These heat exchangers may consist of radiators, condensers or supercharged air coolers. In these heat exchangers, several tubes are stacked on top of each other with heat dissipating elements arranged in-between. The fluid circulates inside the tubes and transfers or captures calories present in the outside air which passes through the dissipating elements of the heat exchanger.

These heat exchangers are conventionally arranged on the front face of motor vehicles in order to capture the outside air, ahead of the engine which is placed in the engine compartment of the motor vehicle.

The frontal position of these heat exchangers exposes the heat exchanger which is closest to the front face of the motor vehicle to the projection of debris or gravel which are in the road and which can damage or even pierce the tubes inside which the fluid circulates. More specifically, the tubes of the heat exchanger arranged closest to the front face of the motor vehicle are arranged transversally to the running direction of the motor vehicle in a flat and horizontal arrangement. As a result, the tubes of this heat exchanger located closest to the front face of the motor vehicle are exposed to the projections of debris or gravel at their edge facing the front face of the vehicle.

In order to protect these heat exchangers, it is known to place in front of them a protective grid capable of retaining the gravel or any other projectile and thus preventing shocks on the tubes of the heat exchangers. It is known for example to arrange a protective grid ahead of the heat exchanger(s) of the motor vehicle, by clipping this protective grid onto the heat exchanger.

### SUMMARY OF THE INVENTION

An object of the invention is a protective grid for a heat exchanger with a bottle, comprising a front face and a rear face, opposed to the front face, the protective grid being attachable to the heat exchanger so that the rear face can face a side of the heat exchanger, wherein the protective grid is configured to extend over the bottle and follow a curvature of the bottle.

In one option, the protective grid includes a first portion extending along a flat plane and a second portion extending along a curved plane, with the second portion being configured to envelop the bottle.

In one option, the second portion is tubular.

In one option, the second portion includes a bottle distancing element protruding from the rear face, intended to ensure a distance between the rear face and the bottle.

In one option, the front face and the rear face at the second portion extend along the curved plane in the same manner.

In one option, the second portion extends beyond the first portion in a direction perpendicular to a general plane of extension of the front face.

In one option, the first portion includes a primary section configured to cover tubes of the heat exchanger, and a secondary section remote with respect to the primary section and configured to extend beyond the bottle, with the second portion being arranged between the primary section and the secondary section.

In one option, the primary section includes primary attachment arrangement for connecting to the heat exchanger.

In one option, the secondary section includes secondary attachment arrangement for connecting to the heat exchanger.

Another object of the invention is a heat exchanger device comprising a heat exchanger with a bottle, and a protective grid including a front face and a rear face, opposed to the front face, the protective grid being attached to the heat exchanger so that the rear face faces a side of the heat exchanger, wherein the protective grid extends over the bottle and follows a curvature of the bottle.

In one option, the protective grid includes a first portion extending along a flat plane and a second portion extending along a curved plane, with the second portion enveloping the bottle.

In one option, the heat exchanger includes a plurality of tubes extending between a first collecting tank and a second collecting tank, wherein the bottle is arranged by the second collecting tank, wherein the protective grid extends over the second collecting tank.

In one option, the protective grid extends over the first collecting tank.

In one option, the first collecting tank includes a fluid block configured as an inlet or outlet for a heat exchange fluid, wherein the protective grid extends over the fluid block.

In one option, the first portion includes a primary section configured to cover at least some of the tubes of the heat exchanger, and a secondary section remote with respect to the primary section and configured to extend beyond the bottle, with the second portion being arranged between the primary section and the secondary section.

In one option, the bottle includes a bottle attachment element, wherein the secondary section includes bottle attachment arrangement for connecting to the heat exchanger, with the bottle attachment element being connected to the bottle attachment arrangement.

### BRIEF DESCRIPTION OF DRAWINGS

The present invention will be described in greater detail below with reference to the drawings. In the drawings:

FIG. 1 shows a heat exchange device 1 in a front perspective view;

FIG. 2 shows a heat exchange device 1 in a rear perspective view;

FIG. 3 shows an enlarged portion of a protective grid 3 in a rear perspective view;

FIG. 4 shows an enlarged portion of a protective grid 3 in a front perspective view;

FIG. 5 shows an enlarged portion of the heat exchange device 1 in a top view; and

FIG. 6 shows schematically the protective grid 3 in a top view.

### DETAILED DESCRIPTION OF THE INVENTION

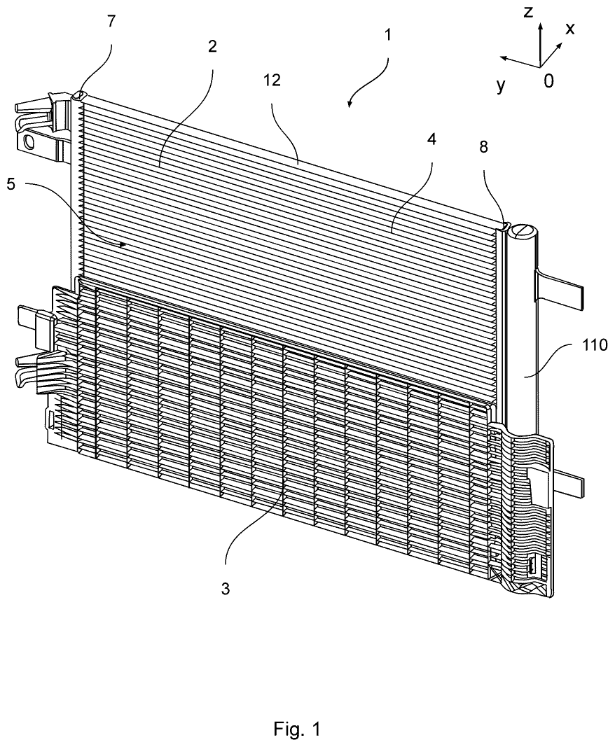

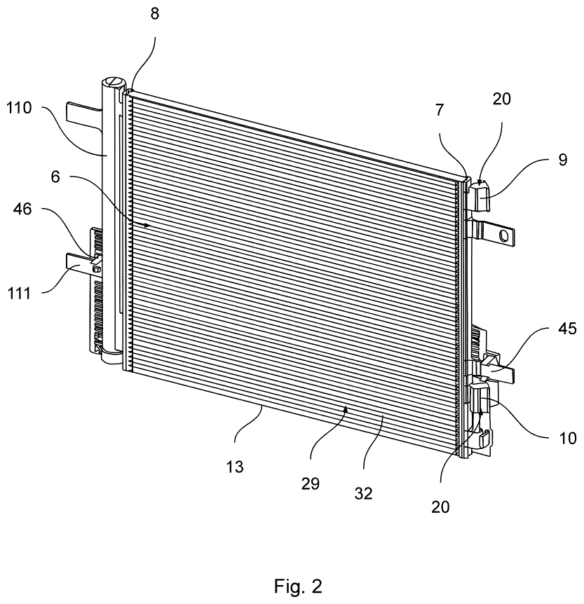

FIG. 1 shows a heat exchange device 1 according to the present invention placed in an orthonormal system Oxyz and comprising at least one heat exchanger 2 and at least one protective grid 3. FIG. 1 shows the heat exchange device 1 in a front perspective view, while FIG. 2 shows a heat exchange device 1 in a rear perspective view.

The heat exchanger 2 comprises a plurality of tubes 4 stacked along a stacking direction Z parallel to a direction Oz of the orthonormal system. The tubes 4 are spaced apart from each other in order to delimit passages configured to be taken by an incoming air flow in a motor vehicle in which is arranged the heat exchange device 1 according to the present invention. In other words, two successive tubes 4 delimit a passage through which the air flow circulates.

Each of these tubes 4 extends mainly along a transverse direction Y, parallel to a direction Oy of the orthonormal system and through which flows a fluid intended to exchange calories with the air flow passing through the heat exchanger 2 via the passages delimited by the tubes 4. The fluid flowing through these tubes 4 may for example be a refrigerant fluid when the heat exchanger 2 is a gas condenser or a gas cooler.

In the orthonormal system Oxyz, the direction Ox thus illustrates a direction along which an air flow can flow through the heat exchange device 1, while the direction Oy illustrates a direction perpendicular to the direction Ox and along which the fluid flows in the tubes 4 of the heat exchanger 2. Finally, the direction Oz is perpendicular to the two other directions mentioned above and illustrates a verticality of the heat exchange device 1. It should be noted that this term of verticality is understood here with reference to an orientation of the heat exchange device 1 in FIG. 1 and in an example of application in a given motor vehicle, but that this designation is not restrictive of the orientation the can be taken by the heat exchange device 1.

The heat exchanger 2 comprises an inlet face 5 and an outlet face 6, respectively arranged one after the other along the direction of movement of the air flow, that is to say along the direction Ox of the orthonormal system. It is thus understood that the inlet face 5 is a face of this heat exchanger 2 through which the air flow is able to enter the heat exchanger 2 and that the outlet face 6 is a face of this heat exchanger 2, opposed to its inlet face 5, and through which the air flow is able to leave the heat exchanger 2. In other words, the heat exchanger 2 is delimited, along the direction Ox, on one hand by this inlet face 5 and on the other hand by the outlet face 6.

Along the direction Oy, the heat exchanger 2 is delimited by a first collecting tank 7 and by a second collecting tank 8. The tubes 4 thus extend mainly between this first collecting tank 7 and this second collecting tank 8. As illustrated in FIG. 1, the first collecting tank 7 comprises an inlet 9 and an outlet 10 through which the fluid circulating in the tubes 4 can enter or leave the heat exchanger 2.

Finally, the heat exchanger 2 is delimited, along the direction Oz, by a first end plate 12 and by a second end plate 13, this first and second end plates 12, 13 facing each other along the vertical direction Oz. Each of these end plates 12, 13 extends mainly along a direction parallel to the axis Oy of the orthonormal system between the first collecting tank 7 and the second collecting tank 8.

As mentioned above, the fluid which circulates in the tubes 4 of the heat exchanger 2 exchanges calories with the air flow which passes through the heat exchanger 2 along the Ox direction.

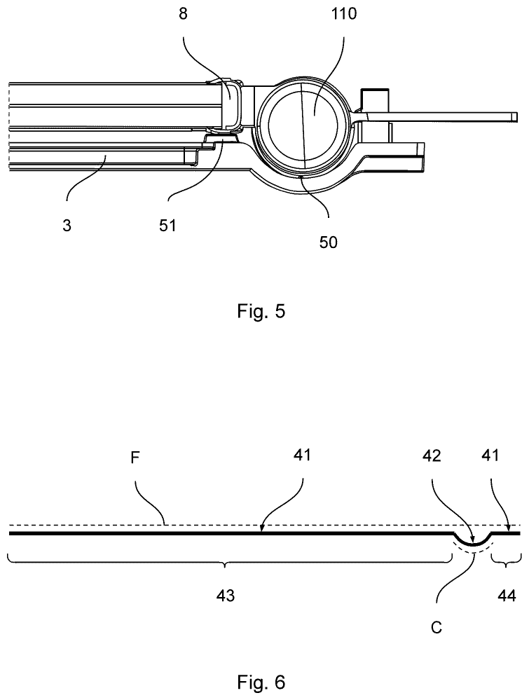

In order to improve this exchange of calories, heat dissipating elements are disposed in the passages taken by the air flow. The tubes 4, the passages delimited by these tubes 4 and the heat dissipating elements will be more fully described hereinafter, in particular with reference to FIG. 5.

As previously mentioned, the heat exchange device 1 according to the invention comprises the heat exchanger 2 and also a protective grid 3 arranged against the inlet face 5 of the heat exchanger 2 through which the air flow is able to enter this heat exchanger 2. In other words, this protective grid 3 is arranged ahead of the heat exchanger 2, the word “ahead” having to be understood with respect to the direction of the air flow passing through the heat exchanger 2.

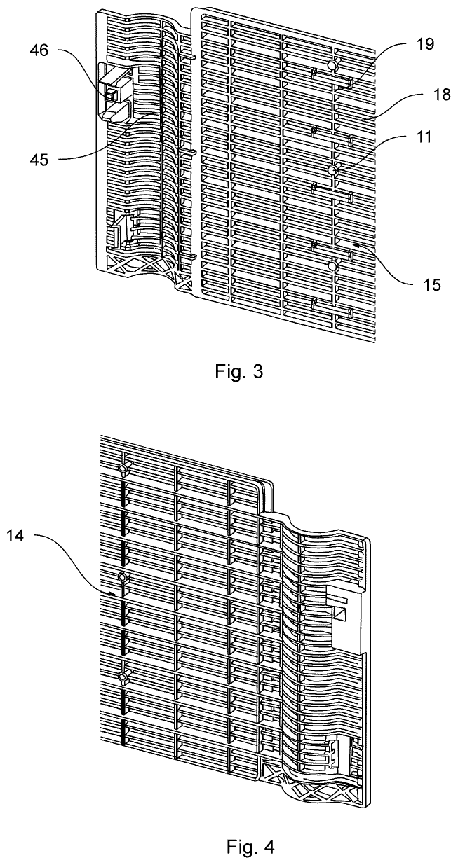

FIG. 3 shows an enlarged portion of a protective grid 3 in a rear perspective view, while FIG. 4 shows an enlarged portion of a protective grid 3 in a front perspective view. FIG. 5 shows an enlarged portion of the heat exchange device 1 in a top view.

The protective grid 3 comprises a front face 14 forming an entrance face of the air flow in the heat exchange device 1 and a rear face 15, opposed to this front face 14 and facing the inlet face 5 of the heat exchanger 2.

According to the invention, the protective grid 3 has a transverse dimension, that is to say measured along a straight line parallel to the axis Oy, less than or equal to a transverse dimension, also measured along a straight line parallel to the axis Oy, of the inlet face 5 of the heat exchanger 2. In other words, this protective grid 3 strictly extends between the first collecting tank 7 and the second collecting tank 8. It will be understood that the main function of this protective grid 3 is to protect the tubes 4 of the heat exchanger 2, it would therefore be useless for this protective grid 3 to extend beyond these heat exchangers tubes 4.

According to another embodiment of the invention not shown here, the protective grid 3 can extend over a whole vertical dimension of the inlet face 5 of the heat exchanger 2, that is to say between the first end cheek 12 and the second end cheek 13, along the direction Oz.

The protective grid 3 comprises at least one series of protective transverse elements 18. As it can be seen in FIG. 3, two successive transverse elements 18 are interconnected by a plurality of vertical elements 19, that is to say parallel to the axis Oz of the orthonormal system, whose function is to bring a mechanical resistance to the plurality of protective transverse elements 18.

The transverse elements 18 are parallel, or substantially parallel, to one another and extend parallel to the direction of extension Y of the tubes of the heat exchanger. Depending on the arrangement of the heat exchanger 2 on the motor vehicle, the transverse elements 18 may be aligned horizontally or vertically. Whatever the orientation of the heat exchanger 2 is, this series of protective transverse elements 18 extend in a plane parallel to a plane in which the inlet face of the heat exchanger is inscribed.

These transverse elements 18 form zones capable of absorbing at least partially the shocks sustained by the heat exchange device 1, for example an impact of a gravel, and prevent this gravel from piercing the tube protected by one of these transverse elements 18. In this way, the transverse elements 18 are protective transverse elements 18 of the tubes 4 of the heat exchanger 2.

Each transverse element 18 extends parallel to the direction of extension Y of the tube which it protects. The transverse element 18 thus forms an elongated element for protecting the tube 4. This or these transverse elements 18 have a band or cord shape. The section of the transverse element 18 is for example circular, ovoid, rectangular or square.

The protective grid 3 according to the invention is made of a synthetic material. Since this protective grid 3 can for example be obtained by injection, injection holes 11 are also visible on the protective grid 3.

As previously mentioned, heat dissipating elements 32 may be disposed in the passages 29 delimited by the tubes 4 in order to improve the exchange of calories between the air flow circulating in these passages 29 and the fluid circulating in the tubes 4 of the heat exchanger 2.

These dissipating elements 32 are, for example, fins or spacers, for example provided with louvers, each fin or spacer being disposed between two tubes 4 immediately adjacent to each other.

The heat exchanger 2 can include a bottle 110 fluidically connected to the tubes 4 to enable the second fluid flow in the bottle 110. Here, the bottle 110 is receiver drier adapted to remove moisture content from the second fluid and act as a reservoir for the second fluid. The shape of the bottle 110 can be a tubular cylinder elongated along in the Z direction.

FIG. 6 shows schematically the protective grid 3 in a top view.

In general, the protective grid 1 is configured to extend over the bottle 110 and follow a curvature of the bottle 110.

The protective grid 1 can include a first portion 41 extending along a flat plane F and a second portion 42 extending along a curved plane C, with the second portion 42 configured to envelop the bottle 110. In particular, the second portion 42 can envelop a portion of the bottle 110, for example a part of its circumference and/or a part of its height (in Z direction).

The second portion 42 can be tubular. In particular, the tubular shape can correspond to the tubular shape of the bottle 110.

The second portion 42 can include a bottle distancing element 50 protruding from the rear face 15, intended to ensure a distance between the rear face 15 and the bottle 110.

Similarly, the protective grid 3 can include a grid distancing element 51 to ensure a distance between the rear face 15 and the tubes 4 and/or the first collecting tank 7 and/or the second collecting tank 8.

Preferably, the front face 14 and the rear face 15 at the second portion 42 extend along the curved plane C in the same manner. For example, the front face 14 and the rear face 15 maintain their distance to the bottle 110 as they extend along its circumference.

The second portion 42 can extend beyond the first portion 41 in a direction perpendicular to a general plane of extension of the front face 14. Similarly, the second portion 42 can extend beyond the first portion 41 in a direction perpendicular to a general plane of extension of the rear face 15.

The first portion 41 can include a primary section 43 configured to cover tubes 4 of the heat exchanger 2, and a secondary section 44 remote with respect to the primary section 43 and configured to extend beyond the bottle 110. The second portion 42 can be arranged between the primary section 43 and the secondary section 44.

The primary section 43 can include a primary attachment arrangement 45 for connecting to the heat exchanger 2.

The secondary section 44 can include a secondary attachment arrangement 46 for connecting to the heat exchanger 2.

The heat exchanger 2 can include a plurality of tubes 4 extending between the first collecting tank 7 and the second collecting tank 8, wherein the bottle 110 is arranged by the second collecting tank 8. The protective grid 3 can extend over the second collecting tank 8.

The protective grid 3 can extend over the first collecting tank 7.

The first collecting tank 7 generally can include a fluid block 20 configured as an inlet 9 or outlet 10 for a heat exchange fluid. The protective grid can extend over the fluid block 20.

The bottle 110 can include a bottle attachment element 111, wherein the secondary section 44 includes bottle attachment arrangement 45 for connecting to the heat exchanger 2. The bottle attachment element 111 can connected to the bottle attachment arrangement 45, for example using a clip assembly.

1. A protective grid for a heat exchanger with a bottle, comprising a front face and a rear face, opposed to the front face, the protective grid being attachable to the heat exchanger so that the rear face can face a side of the heat exchanger, wherein the protective grid is configured to extend over the bottle and follow a curvature of the bottle.

2. The protective grid according to claim 1, wherein the protective grid includes a first portion extending along a flat plane and a second portion extending along a curved plane, with the second portion being configured to envelop the bottle.

3. The protective grid according to claim 2, wherein the second portion is tubular.

4. The protective grid according to claim 2, wherein the second portion includes a bottle distancing element protruding from the rear face, intended to ensure a distance between the rear face and the bottle.

5. The protective grid according to claim 2, wherein the front face and the rear face at the second portion extend along the curved plane in the same manner.

6. The protective grid according to claim 2, wherein the second portion extends beyond the first portion in a direction perpendicular to a general plane of extension of the front face.

7. The protective grid according to claim 2, wherein the first portion includes a primary section configured to cover tubes of the heat exchanger, and a secondary section remote with respect to the primary section and configured to extend beyond the bottle, with the second portion being arranged between the primary section and the secondary section.

8. The protective grid according to claim 7, wherein the primary section includes primary attachment arrangement for connecting to the heat exchanger.

9. The protective grid according to claim 7, wherein the secondary section includes secondary attachment arrangement for connecting to the heat exchanger.

10. A heat exchanger device comprising a heat exchanger with a bottle, and a protective grid including a front face and a rear face, opposed to the front face, the protective grid being attached to the heat exchanger so that the rear face faces a side of the heat exchanger, wherein the protective grid extends over the bottle and follows a curvature of the bottle.

11. The heat exchanger device according to claim 10, wherein the protective grid includes a first portion extending along a flat plane and a second portion extending along a curved plane, with the second portion enveloping the bottle.

12. The heat exchanger device according to claim 10, wherein the heat exchanger includes a plurality of tubes extending between a first collecting tank and a second collecting tank, wherein the bottle is arranged by the second collecting tank, wherein the protective grid extends over the second collecting tank.

13. The heat exchanger device according to claim 12, wherein the protective grid extends over the first collecting tank.

14. The heat exchanger device according to claim 12, wherein the first collecting tank includes a fluid block configured as an inlet or outlet for a heat exchange fluid, wherein the protective grid extends over the fluid block.

15. The heat exchanger device according to claim 12, wherein the first portion includes a primary section configured to cover at least some of the tubes of the heat exchanger, and a secondary section remote with respect to the primary section and configured to extend beyond the bottle, with the second portion being arranged between the primary section and the secondary section.

16. The heat exchanger device according to claim 15, wherein the bottle includes a bottle attachment element, wherein the secondary section includes bottle attachment arrangement for connecting to the heat exchanger, with the bottle attachment element being connected to the bottle attachment arrangement.
